(19) United States
(12) Patent Application Publication
(10) Pub. No.: US 2007/0221082 A1
(43) Pub. Date: Sep. 27, 2007

(54) Method for Preparing Offset Printing Plate

(75) Inventors: Kenji Fukui, Chiba (JP); Hironori Sato, Saitama (JP); Yoshio Bizen, Tokyo (JP)

Correspondence Address: BACON & THOMAS, PLLC, 625 SLATERS LANE, FOURTH FLOOR, ALEXANDRIA, VA, 22314, US

(73) Assignee: Kimoto Co.,Ltd., Shinjuku--ku (JP)

(21) Appl. No.: 11/631,306

(22) PCT Filed: Jul. 12, 2005
(86) PCT No.: PCT/JP05/12846

§ 371 Date: Jan. 3, 2007

(30) Foreign Application Priority Data
Jul. 13, 2004 (JP) 2004-205386

(51) Int. Cl. B41N 3/00

(52) U.S. Cl. 101/463.1

(57) ABSTRACT

In the preparation of an offset printing plate comprising forming printing plate images with droplets of lipophilic ink by using a printing means based on the inkjet method, lipophilic ink having a UV curing property is used, and a UV lamp 7 is also carried on a carriage 8 carrying a printing head 6. While performing multipass printing by a dot thinning method for the main scanning direction and subscanning direction with the printing head 6, droplets on a printing plate material 2 immediately after the printing are cured with ultraviolet rays irradiated by the UV lamp 7. Moreover, ultraviolet rays are irradiated also in the period of returning of the carriage 8. Since blotting of the droplets immediately after printing do not overlap with one another, and the droplets are cured in every pass, extremely precise tone reproduction can be realized. Moreover, as the UV lamp 7, a UV lamp of a small output capacity can be used, and thus cost of the apparatus can be reduced.

### TECHNICAL FIELD

The present invention relates to a method for preparing an offset printing plate, in particular, improvement in forming images with lipophilic ink on a printing plate material using a printing means based on the inkjet method for suppressing blotting of droplets forming dots to realize highly precise tone reproduction.

### BACKGROUND ART

Offset printing is a printing method in which ink adhering to a printing plate surface is not directly transferred to paper, but the ink is once transferred to a rubber blanket or the like and then transferred to a material to be printed such as paper. Although there are various methods for preparing offset printing plates, they can be roughly classified into analog platemaking methods using PS plates and direct platemaking methods using a comparatively simple DTP technique, as the most common methods.

The platemaking methods using PS plates constitute the mainstream of the conventional methods, in which a photographic film of an original is prepared beforehand, and then superimposed on a PS plate comprising an aluminum substrate on which a photosensitive resin is laminated, and light exposure (printing) and dissolution of unexposed portions (development) are performed to obtain the aluminum plate on which exposed portion remain as a printing plate.

On the other hand, the direct platemaking methods are methods of directly forming original images on a substrate such as plastic or aluminum plates without using a block copy film as in the conventional methods, and electrophotographic methods and silver photographic methods have conventionally been used in many cases. However, methods based on the inkjet method, thermal transfer method, or discharge transfer method are also practically used.

Among the direct platemaking methods, those using the inkjet method are techniques existing from old time as seen from, for example, Patent documents 1 to 5 mentioned below, and they are methods of scanning a surface of a support having an image receiving layer with a printing means based on the inkjet method discharging droplets of lipophilic ink to form images of a printing plate.

According to the methods of this type, a printing plate can be directly prepared without a procedure of once printing out electronized information of an original as a hard copy, and they further have convenience that, for example, the information of the original can be stored in a storage medium, and freely edited on a personal computer or the like.

Further, Patent document 2, 3 and 4 contemplate to use ink having an ultraviolet curing property as the lipophilic ink, cure and fix images formed with the lipophilic ink on a support by ultraviolet rays to obtain a highly durable printing plate.

Patent document 1: Japanese Patent Unexamined Publication (KOKAI) No. 51-84303

Patent document 2: Japanese Patent Unexamined Publication (KOKAI) No. 56-113456

Patent document 3: Japanese Patent Unexamined Publication (KOKAI) No. 56-105960

Patent document 4: Japanese Patent Unexamined Publication (KOKAI) No. 5-269958

Patent document 5: Japanese Patent Unexamined Publication (KOKAI) No. 9-58144

### DISCLOSURE OF THE INVENTION

### Problem to be Solved by the Invention

However, since ink receiving capacity of image receiving layers as surfaces of printing plate materials is not generally so large, and they basically have a structure showing favorable affinity to liquid (porous surface structure etc.), they have a problem of blotting of ink. The inventors of the present invention conducted printing experiments using a printing head (resolution: 1200 dpi, droplet: 1 drop consists of 6 μl) in order to evaluate limit of halftone dot quality in the platemaking methods based on the inkjet method using lipophilic ink. The results showed that, as the amount of ink adhered to a printing plate material increased in a unit area, blotting became more significant, and change in the ratio of spreading of the blotting tended to increase with the amount of ink. Moreover, it was observed that as the areas of the halftone dots became larger (density became higher), the shapes of blotting regions were irregularly collapsed.

Such a blotting phenomenon of lipophilic ink constitutes a factor for degrading tone reproduction of prepared printing plates, and reducing printed image quality, and makes the design of halftone dot pattern extremely difficult.

Therefore, an object of the present invention is to provide a method for preparing an offset printing plate and platemaking apparatus which solve the problem concerning the tone reproduction of offset printing plates caused by the blotting phenomenon of lipophilic ink at the time of platemaking.

### MEANS FOR SOLVING THE PROBLEM

The method for preparing an offset printing plate of the present invention is a method for preparing an offset printing plate comprising scanning an image receiving layer provided on a surface of a support with a printing means based on the inkjet method discharging droplets of lipophilic ink to form images of the printing plate, wherein ink having an ionizing radiation curing property is used as the lipophilic ink, multipass printing is performed with a printing head of the printing means with dot thinning for a main scanning direction and a subscanning direction, and droplets adhered on the image receiving layer in each pass of the multipass printing are cured by irradiation of ionizing radiation during a period after adhesion of the droplets and before start of printing in the next pass.

The platemaking apparatus of the present invention is a platemaking apparatus comprising a printing means provided with a printing head for performing printing by injecting ink droplets to a printing plate material, a carriage carrying the printing head, a driving means for reciprocally moving the carriage along a first direction with the printing head facing the printing plate material, a carrying means for intermittently feeding the printing plate material along a second direction perpendicular to the first direction, and a control means for controlling operations of the driving means, the printing means, and the carrying means, wherein the carriage carries an ionizing radiation irradiation unit for curing ink droplets injected on the printing plate material by the printing head, and the control means performs such control that multipass printing should be performed to repeat printing with thinning dots of printing data for the first and second directions, and the ink droplets injected on the printing plate material by the printing head in printing of each pass should be irradiated with ionizing radiation during a period after injection of the droplets and before start of printing in the next pass.

In the present invention, the printing means performs multipass printing by a dot thinning printing method for a main scanning direction and a subscanning direction. With the control of droplet injection by such a dot thinning printing method, the adhesion intervals of droplets (intervals between dots) can be set to be so wide that blotting regions of adjacent individual dots formed by scanning of each pass should not overlap with one another.

Moreover, since lipophilic ink having an ionizing radiation curing property is used, and printed droplets of ink are cured by irradiation of ionizing radiation during a period until the start of printing of the next pass, spreading of a blotting region of each droplet is limited in that period, blotting regions are fixed in scanning of each pass, and the fixed regions do not further enlarge.

The ionizing radiation includes invisible electromagnetic waves such as ultraviolet rays and electron beams.

In the present invention, if both the printing head of the printing means and the ionizing radiation irradiation unit are installed on the carriage moving along the main scanning direction so as to irradiate the printed droplets with ionizing radiation, the droplets can be cured at an early timing after the printing.

However, when the droplets are cured only during the outgoing movement of the carriage, the droplets should be cured by short time irradiation of ionizing radiation, and therefore radiation capacity of the ionizing radiation irradiation unit should be set at a considerably high level.

Concerning this problem, if irradiation by the ionizing radiation irradiation unit is maintained also during a period of returning movement of the printing head after completion of printing in each pass, it becomes possible to irradiate the ionizing radiation with effectively utilizing periods of returning of the printing head between the passes, and thus the radiation capacity of the ionizing radiation irradiation unit can be made smaller.

Furthermore, even after the return of the carriage, if the carriage is reciprocally moved one or more times along the main scanning direction with maintaining the irradiation by the ionizing radiation irradiation unit and non-printing state of the printing head, the irradiation time can be extended, and thus the irradiation capacity of the ionizing radiation irradiation unit can be correspondingly made further smaller.

### EFFECT OF THE INVENTION

According to the present invention, in a method for preparing a printing plate in which images of the printing plate are formed by scanning with a printing means based on the inkjet method discharging droplets of lipophilic ink, two kinds of measures, execution of multipass printing by the dot thinning printing method for the main scanning direction and subscanning direction, and use of lipophilic ink having an ionizing radiation curing property, of which droplets after printing in each pass are cured by irradiation of ionizing radiation before start of the next pass, are combined, thereby blotting of individual dots can be suppressed, and platemaking of printing plates showing superior tone reproduction is attained.

In particular, the configuration that the carriage carries both the printing head and the ionizing radiation irradiation unit can even deal with a case in which blotting rate is high due to characteristics of image receiving layer or lipophilic ink, and thinning ratio in the dot thinning printing method is low.

Moreover, the present invention also has the following secondary advantages.

(1) Some of printing heads based on the inkjet method used for platemaking apparatuses for preparing printing plates are constituted so that hot water of a predetermined temperature should circulate in the inside of the heads in order to maintain viscosity of lipophilic ink constant, and cool the heat generated by the heads themselves. However, according to the present invention, dot thinning printing is performed in each scanning, therefore the calorific value is markedly reduced, and the heat can be sufficiently dealt by natural cooling or air cooling, which realizes reduction of costs for parts.

(2) In the conventional platemaking apparatuses for preparing printing plates using lipophilic ink having an ultraviolet curing property, it is necessary to use an ultraviolet lamp of large capacity, because ultraviolet irradiation is performed after formation of images on printing plate is finished. However, according to the present invention, since the dose of the ionizing radiation for curing the droplets printed by the dot thinning printing may be supplied as an integrated dose, capacity of the ionizing radiation irradiation unit can be made smaller, and thus reduction of costs for parts can be attained.

Furthermore, by irradiation of ionizing radiation using the returning period of the carriage, or by providing a period of reciprocal movement of the carriage in non-printing state only for irradiation of ionizing radiation, the capacity of the ionizing radiation irradiation unit can be made markedly smaller, and thus the cost for parts can be further reduced.

### BEST MODE FOR CARRYING OUT THE INVENTION

Hereafter, embodiments of the platemaking apparatus and platemaking method for preparing printing plate of the present invention will be explained in detail with reference to the drawings.

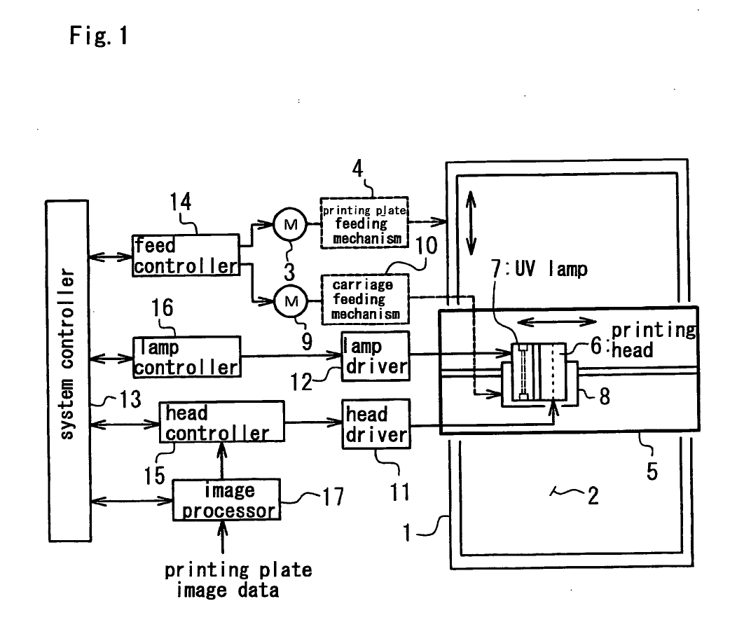

FIG. 1 shows configuration of an embodiment of the platemaking apparatus for preparing a printing plate of the present invention. This platemaking apparatus is provided with a printing plate material feed bar 1 on which a printing plate material 2 is placed, a carriage 8 carrying a printing head 6 based on the inkjet method and an ultraviolet lamp (henceforth referred to as “UV lamp”) 7, and a fixing casing 5 integrally provided with a running route for moving the carriage 8 along the main scanning direction. The printing plate material feed bar 1 is moved along the subscanning direction by a printing plate feeding mechanism 4 driven by a motor 3. The carriage 8 is reciprocally moved on the running route integrally provided in the fixing casing 5 by a carriage moving mechanism 10 driven by a motor 9.

The printing head 6 carries an ink cartridge (not shown) storing lipophilic ink having a UV curing property, and is driven so that droplets of the lipophilic ink in the ink cartridge should be discharged from nozzles by a head driver 11. The printing head 6 is provided with a multiple number (corresponding to the number of channels) of nozzles aligned along the subscanning direction, and the head driver 11 drives discharge of droplets for each nozzle.

As the printing plate material 2, one in which a hydrophilic layer (image receiving layer) showing a receptive property to lipophilic ink is formed on a surface of a support is prepared.

The UV lamp 7 is turned on and off by a lamp driver 12. The UV lamp 7 is disposed with a predetermined gap with respect to the printing head 6 so that the axis of the lamp should be parallel to the alignment direction of the nozzles of the printing head 6. Moreover, a light shielding plate (not shown) is provided between the UV lamp 7 and the nozzles of the printing head 6, so that the lipophilic ink should not be cured at tips of the nozzles by ultraviolet rays from the UV lamp 7.

The motors 3 and 9, the head driver 11, and the lamp driver 12 are controlled by a feed controller 14, a head controller 15, and a lamp controller 16, respectively, which are under comprehensive control by a system controller 13.

The head controller 15 incorporates printing plate image data processed in an image processing means 17, and controls discharge of droplets from the printing head 6 driven by the head driver 11. The feed controller 14 controls feeding of the carriage 8 along the main scanning direction and feeding of the printing plate material feed bar 1 along the subscanning direction, and the lamp controller 16 controls turning on and off of the UV lamp 7. The system controller 13 supervises data processing status in the image processing means 17 and the head controller 15, and sends directions to the feed controller 14 and the lamp controller 16 so that the carriage 8 and the printing plate material feed bar 1 should be fed and the UV lamp 7 should be turned on and off at predetermined timings according to the processing status. The control by the system controller 13 described above can be executed by using a program (software) incorporated beforehand.

Hereafter, a platemaking method for preparing a printing plate using a platemaking apparatus having the above configuration will be explained. In the platemaking method of the present invention, printing plate images are formed by multipass printing.

Explanation will be made here by exemplifying a case in which the multipass printing is performed with channel number Nc of the printing head 6 of 318, and channel pitch Pc of the printing head 6 of 169 μm (channel density: 150 cpi), and printing of one line is attained by two passes of the printing head to ultimately form printing plate images of 1200 dpi.

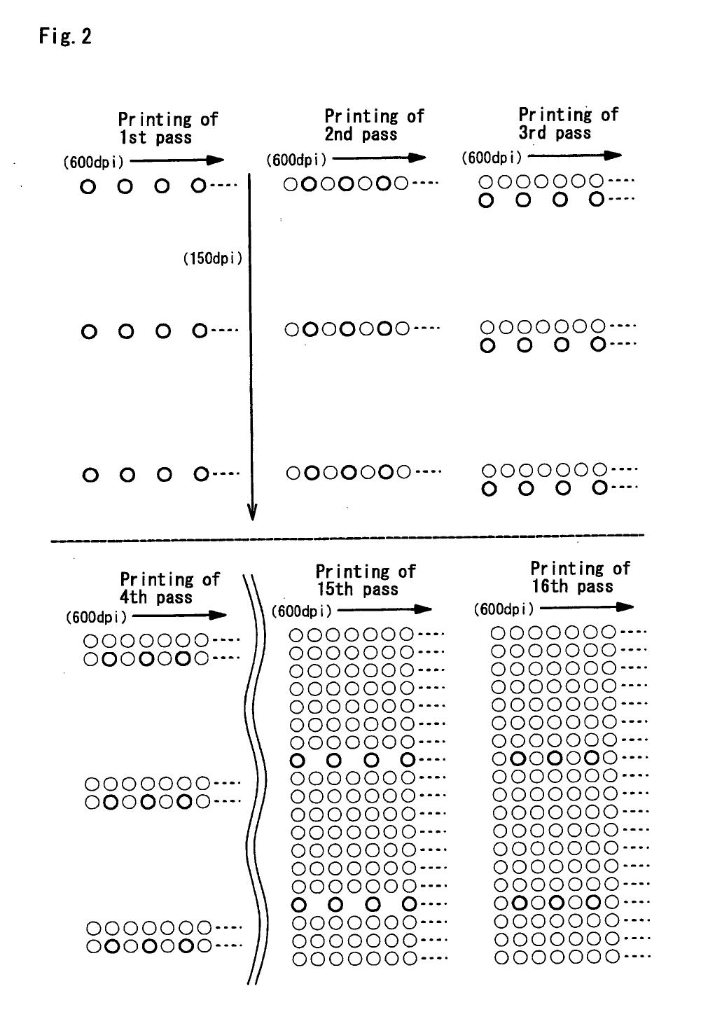

That is, as shown in FIG. 2, in each channel, odd-numbered dots along the direction of the line are printed at 600 dpi in a pass of an odd-numbered order, and even-numbered dots of the same line are printed similarly at 600 dpi in a pass of an even-numbered order. When a pass of even-numbered order is finished, the printing plate material 2 is moved along the subscanning direction for a length smaller than the channel pitch Pc, for example, 21.1 μm (=Pc/8), and printing of the next line is repeated. Dot thinning printing is thereby performed for the main scanning direction and the subscanning direction.

In this case, data incorporation may be attained by either a method of inputting data for which thinning is performed beforehand into the image processing means 17, or a method of once storing the whole printing-plate image data in a memory by the image processing means 17 and reading only thinned data for the first pass.

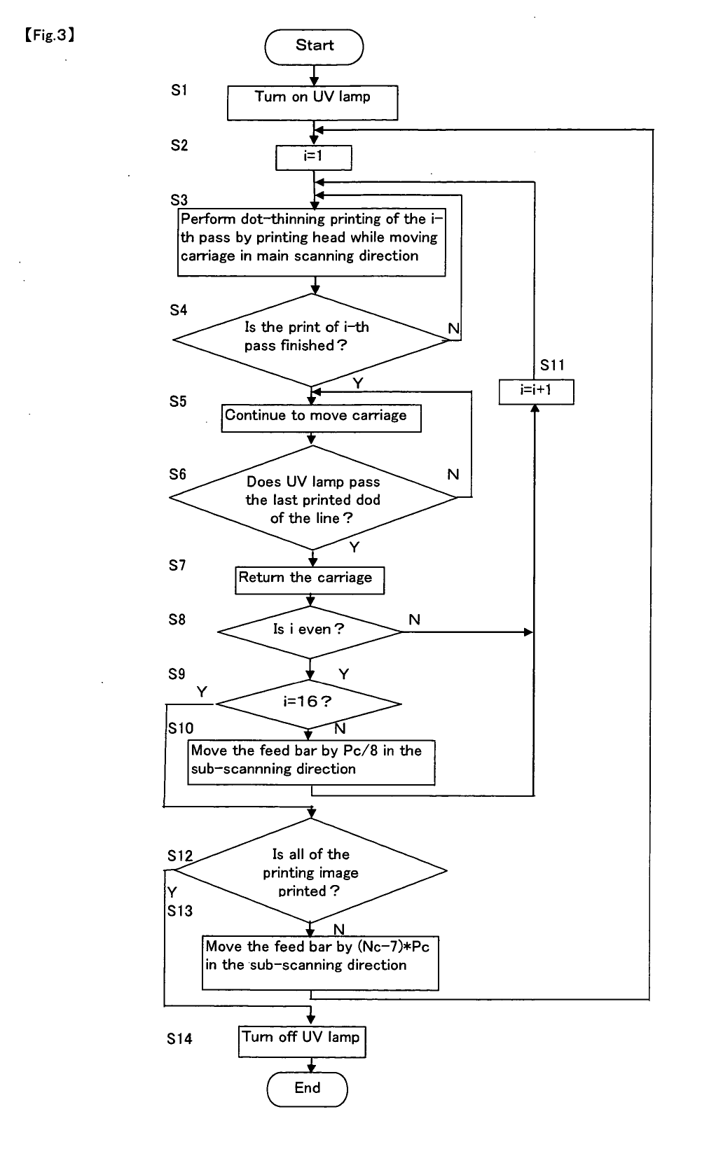

Hereafter, the first embodiment of the platemaking method of the present invention adopting such multipass printing will be explained by referring to FIG. 3. FIG. 3 shows a flowchart representing operation procedures of the first embodiment.

First, the printing plate material feed bar 1 is moved so that the nozzles of the printing head 6 should be disposed at positions corresponding to the first recording line on the printing plate material 2, and the carriage 8 is set at a left position along the main scanning direction as an initial condition.

When starting the operation, the UV lamp 7 is first turned on (S1), then printing plate image data are incorporated, and printing of the first pass is performed (S2, S3). In this printing, droplets of lipophilic ink having an ultraviolet curing property are selectively discharged from the nozzles of the printing head 6 on the basis of the dot thinning data with moving the carriage 8 along the main scanning direction to adhere the droplets as dots on a hydrophilic layer as the surface of the printing plate material 2.

This printing is printing for the first pass, and therefore it is dot thinning printing at 600 dpi in which printing of only the odd-numbered dots is assigned as shown in FIG. 2. Even after the printing of the first pass by the printing head 6 is completed, the carriage 8 is continuously moved, and when the UV lamp 7 passes the last recording dot of the line, the carriage 8 is returned (S4 to S7).

Since the first pass is a pass of an odd-numbered order, printing of the second pass is started at the returned position (S8->S11->S3).

The printing of the second pass is dot thinning printing assigned only for even-numbered dots for complementing the spaces between the dots printed by the first pass as shown in FIG. 2, and it is of course printing at 600 dpi (S3).

Also in this printing of the second pass, the carriage 8 is continuously moved even after the printing of the pass is completed, and when the UV lamp 7 passes the last recording dot of the line, the carriage 8 is returned, as in the first pass (S4 to S7).

However, this printing is a printing of a pass of a plural-numbered order, and printing for lines of the channels are completed by the first pass and the pass of this time. Therefore, the printing plate material feed bar 1 is moved for a length of the channel pitch Pc/8 (21.1 μm) along the subscanning direction, and then printing of the third pass is started (S8, S9, S10->S11->S3).

Thereafter, dot thinning printing is performed by repeating printing of passes of odd-numbered orders and passes of even-numbered orders. When the printing of the 16th pass is completed, printing filling the spaces corresponding to gaps between the nozzles of the printing head 6 (channel pitch Pc=169 μm) with 8 lines is completed. Therefore, the printing plate material feed bar 1 is moved for a length of (Nc−7)×Pc along the subscanning direction, and dot thinning printing is again repeated from the first pass in the same manner as described above (S9->S12, S13->S2 to S13).

The operations described above are repeatedly performed until all the printing plate image data are printed, and when all the printing is completed, the UV lamp 7 is turned off to end the platemaking for preparing a printing plate (S12->S14).

In the above platemaking operation process, the UV lamp 7 is turned on from the beginning to the end, and the droplets of the dots printed in each pass are immediately irradiated with ultraviolet rays from the UV lamp 7 by the movement of the carriage 8 along the scanning direction with advance of the printing, and also irradiated with ultraviolet rays from the UV lamp 7 while the carriage 8 is returned again to the head of the line.

Therefore, the droplets of the printed dots are cured on the hydrophilic layer of the printing plate material 2 in each pass, and a phenomenon that droplets discharged in printing of each pass are posed on regions of droplets discharged in printing of a previous pass spreading due to blotting to enlarge the blotting regions is hardly caused.

Moreover, as shown in FIG. 2, printing condition in each pass is 1-bit equal thinning for the main scanning direction, and 7-bit equal thinning for the subscanning direction, and droplets of the printed dots cure in each pass. Therefore, droplets of adjacent dots or blotting regions of droplets do not connect immediately after the printing.

Further, as for the printing head 6, if it is a printing head based on the inkjet method, it is necessary to maintain the viscosity of lipophilic ink constant. However, according to the present invention, dot thinning printing is performed as described above, thus calorific power becomes markedly small, and therefore there is also provided an advantage that a simple cooling method based on natural cooling or air cooling is sufficient.

In the first embodiment explained above, droplets of dots after printing are irradiated twice with ultraviolet rays from the UV lamp 7 in each pass. However, if an integrated irradiation dose sufficient for curing the droplets can be obtained by one time of irradiation, a method of curing them only in the period of outgoing movement may be used. In this case, since it is necessary to make illumination higher as much as the irradiation time becomes shorter, a lamp having a large capacity is required as the UV lamp 7.

In order to suppress increase of the production cost of the apparatus due to use of a larger capacity of UV lamp, and effectively use the period of the returning movement only for the returning operation of the carriage 8, it is effective to keep the UV lamp 7 turned on also in the returning period of the carriage 8 to irradiate ultraviolet rays.

Hereafter, the second embodiment of the platemaking method of the present invention using the platemaking apparatus mentioned above will be explained. In the first embodiment, droplets of lipophilic ink after printing are irradiated twice with ultraviolet rays in the process of movement of the carriage 8 along the main scanning direction with the printing head 6 in printing state and the returning process of the carriage 8. However, in this embodiment, an operation of continuing only irradiation by the UV lamp while reciprocally moving the printing head in a non-printing state in each pass is added to increase the number of UV irradiation per pass and thereby contemplate further reduction of the UV lamp capacity.

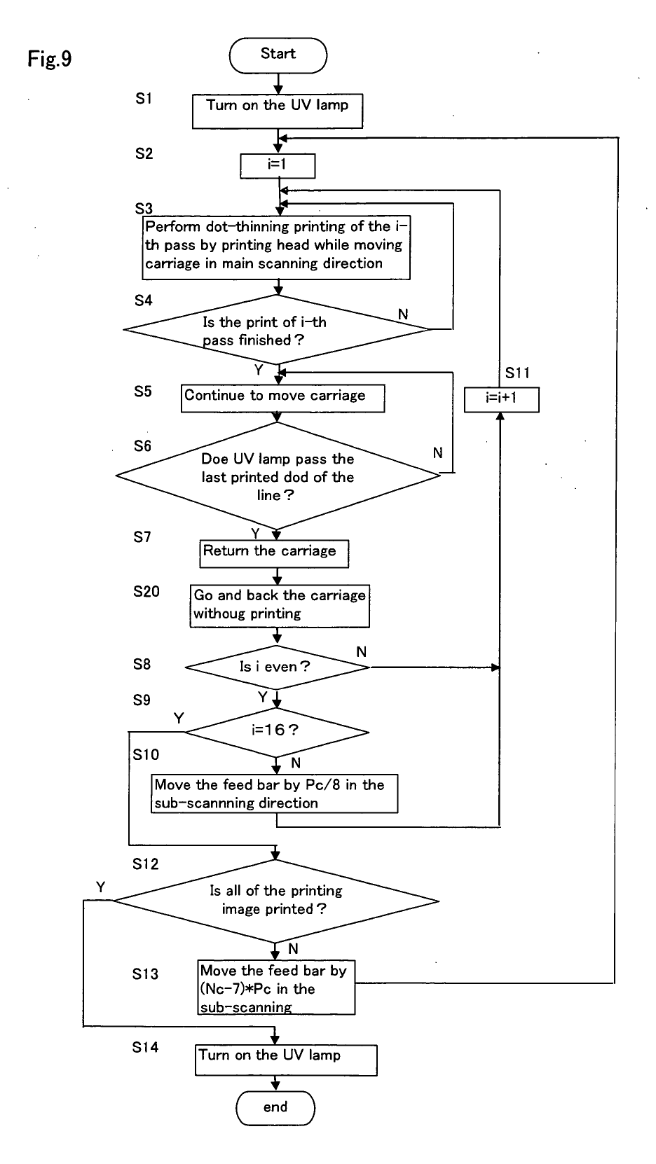

FIG. 9 shows a flowchart representing operations of the second embodiment. Also in this embodiment, thinned printing is performed for a pass of odd-numbered order and a pass of an even-numbered order as a pair to attain printing of one line, as in the first embodiment. However, in this embodiment, after the carriage is returned after a pass of an odd-numbered order, the carriage is reciprocated once before a pass of an even-numbered order without operating the printing head. That is, a process of reciprocating the carriage 8 once in non-printing state (S20) is inserted after the step S7 in the flowchart of FIG. 3. UV irradiation is thereby performed 4 times in total in each pass, and therefore capacity of the UV lamp 7 can be made further smaller. In addition, since the UV irradiation is performed between a pass of an odd-numbered order and a pass of an even-numbered order for printing the same line, it is possible to more surely prevent connection of droplets of dots or blotting regions of droplets.

Such addition of reciprocal movement of the carriage in non-printing state may be variously changed. For example, besides the addition exemplified as the second embodiment, two or more times of the movement may be added, or the movement may be inserted between a pass of an even-numbered order and a pass of the next line. These changes can be easily dealt by changing the software installed in the system controller. Moreover, since the velocity of the carriage 8 for the reciprocal movement can also be arbitrarily determined, the velocity may be changed depending on conditions such as types of lipophilic ink and printing plate material.

Although the aforementioned embodiments are explained by exemplifying multipass printing in which printing of one line is performed with two times of passes of the printing head, it is also possible to change it so that printing of one line should be performed by three or more times of passes.

### EXAMPLE

Hereafter, an example of the platemaking method of the present invention will be explained.

### Example and Comparative-Example 1

1. Determination of UV Lamp

In order to prepare a printing plate by using a platemaking apparatus of the following specification and evaluate tone reproduction thereof, required performance of UV lamp was examined first.

[Specification of Printing Head]

Printing method: On-demand piezo method

Printable Area: 53.573 mm

Number of channels: 318/head

Resolution: 150 cpi

Channel pitch: 169 μm

Minimum drop volume: 6 μl

Gradation: Multidrop

Standard grayscale: 8 levels (7 drops)

Standard frequency: 4.8 KHz/dot (at 7 drops)

Linear speed: 0.41 m/sec (24 m/min) (at 7 drops, 300 dpi)

Standard Ink: Oil based pigment ink/UV curable pigment ink

[Composition of Lipophilic Ink]

| | |
|---|---|
| Acrylic esters | 5 to 15% by weight |
| Isobornyl acrylate | 30 to 50% by weight |
| Tripropylene glycol diacrylate | 15 to 30% by weight |
| Black pigment | 2 to 4% by weight |

The condition required for curing of the aforementioned lipophilic ink is 400 mJ for an ink film thickness of 8 μm. Since the printable area of the printing head is about 5.36 cm, an ultraviolet irradiation window was determined to be 53.6 cm×1 cm. For these conditions, required performance of the UV lamp was examined and determined as follows.

The droplet discharge speed of the printing head is 4.8 kHz/dot (at 7 drops), and it is 33.6 kHz (=4.8×7) for 1 drop. If it is temporarily decided to perform the printing at 1200 dpi (=472 dot/cm), time for passing the ultraviolet irradiation window is calculated to be 14 msec (=472/33.6×10³). Therefore, if the ink should be cured within that time, an illumination of 28.57 W/cm² (=400 mJ/14 msec) is required for it. Supposing that ultraviolet rays of that illumination can be focused in the ultraviolet irradiation window, an UV lamp of 153 W (=28.57×5.36) is needed.

However, if the dot thinning printing is performed, and the ultraviolet irradiation is also performed at the time of the returning of the carriage 8, use of a UV lamp of about 80 W, about a half of the performance determined in the above examination, is sufficient. Therefore, an UV lamp of the following specification was used as the UV lamp.

[Specification of UV Lamp]

Lamp: D valve (wavelength: 350 to 400 nm)

Output: 80 W

2. Preparation of Printing Plate Material

As printing plate materials, two kinds of the following samples, Samples H and I, were prepared.

[Specification of Printing Plate Materials]

Sample H

Dispersion A for image receiving layer having the following composition was prepared, and Coating solution B for image receiving layer was further prepared by using Dispersion A. Then, Coating solution B for image receiving layer was applied on a polyester film having a thickness of 188 μm which had been subjected to an easy adhesion treatment using an undercoat layer, and dried to form an image receiving layer having a thickness of 7 μm and thereby prepare a printing plate material.

<Dispersion A for Image Receiving Layer>

| | |
|---|---|
| Inorganic microparticles (titanium oxide, mean particle | 15 weight parts |
| diameter: 0.12 μm, FA55W, FURUKAWA | |
| CO., LTD.) | |
| Inorganic microparticles (colloidal silica, primary | 3 weight parts |
| particle diameter: 12 nm, Aerosil 200, NIPPON | |
| AEROSIL CO., LTD.) | |
| Polyvinyl alcohol (10% aqueous solution, Gosenol | 100 weight parts |
| NM11, Nippon Synthetic Chemical Industry Co., Ltd.) | |
| Isopropyl alcohol | 40 weight parts |
| Distilled water | 100 weight parts |

<Coating Solution B for Image Receiving Layer>

| | |
|---|---|
| Dispersion A for image receiving layer | 100 weight parts |
| Surface roughening agent (amorphous silica, mean | 7 weight parts |
| particle diameter: 1.9 μm, Sylysia 530, Fuji Silysia | |
| Chemical Ltd.) | |
| Tetraalkoxysilane hydrolysate | 15 weight parts |

The tetraalkoxysilane hydrolysate was obtained by mixing 100 weight parts of tetraethoxysilane (reagent of Wako Pure Chemical Industries Co., Ltd), 100 weight parts of ethanol and 200 weight parts of 0.1 N aqueous hydrochloric acid to allow a hydrolysis reaction at room temperature for 24 hours.

Sample I

A printing plate material was prepared in the same manner as that used for Sample H except that the amount of the titanium oxide in Dispersion A for image receiving layer was changed to 20 weight parts, and the amount of the surface roughening agent in Coating solution B for image receiving layer was changed to 5 weight parts.

3. Evaluation of Tone Reproduction of Printing Plates

From two kinds of the samples mentioned above, printing plates was prepared by the platemaking method according to the first embodiment using each of the following two kinds of dot thinning printing methods and data for each level of tone reproduction (printing data for 0 to 100% of densities divided into 20 stages). Images were printed by using each of the obtained printing plates, and gradation was measured in each of the regions in the printed images corresponding to the aforementioned printing data. Tone reproduction characteristic was evaluated by comparing the measured gradations with a linear density/gradation characteristic.

### EXAMPLE

### Printing at 600 dpi

This printing corresponded to the dot thinning printing explained with reference to FIG. 2. Printing was performed with 1-bit equal thinning condition for the main scanning direction, and 7-bit equal thinning condition for the subscanning direction (600 dpi for the main scanning direction, 150 dpi for the subscanning direction), and UV irradiation was performed from the start to the end of the printing.

### Comparative Example 1

### Printing at 1200 dpi

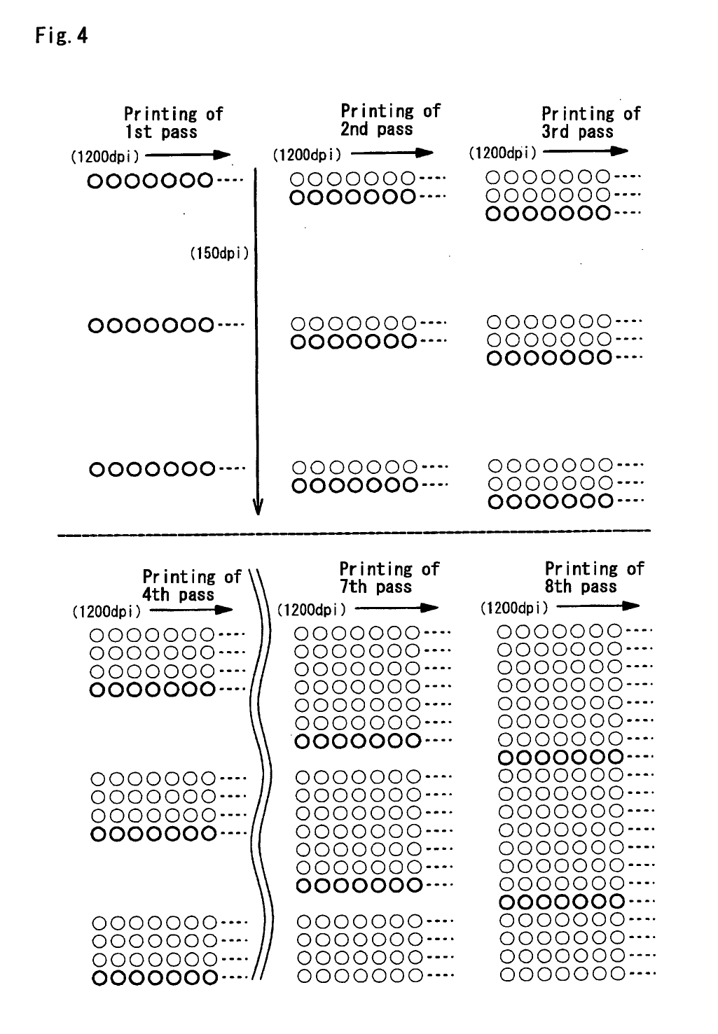

This printing corresponded to the dot thinning printing shown in FIG. 4. Printing was performed with no thinning for the main scanning direction, and 7-bit equal thinning condition only for the subscanning direction as in the example (1200 dpi for the main scanning direction, 150 dpi for the subscanning direction), and UV irradiation was performed from the start to the end of the printing.

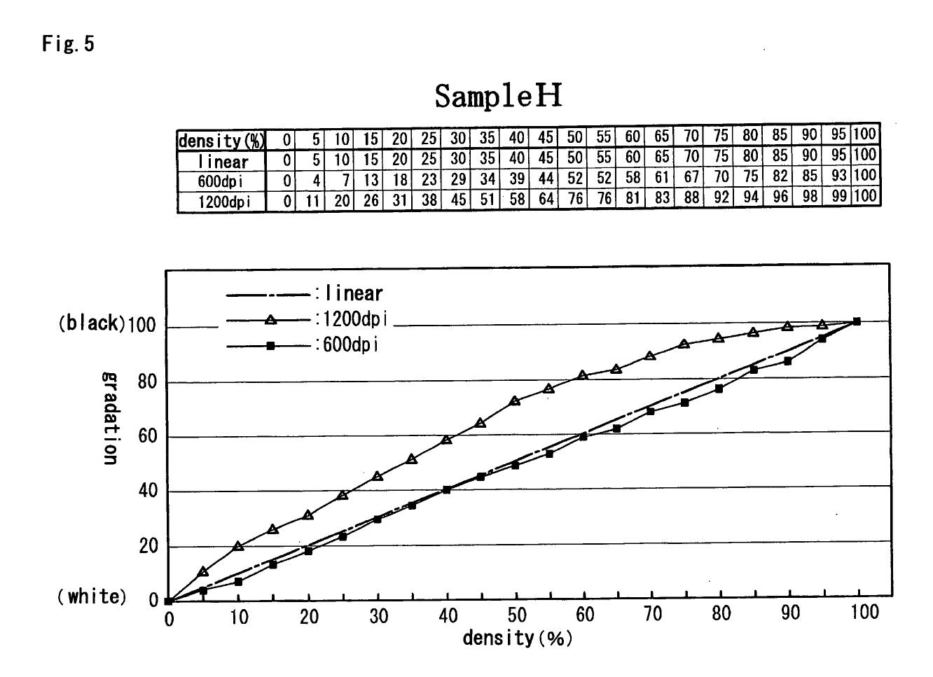

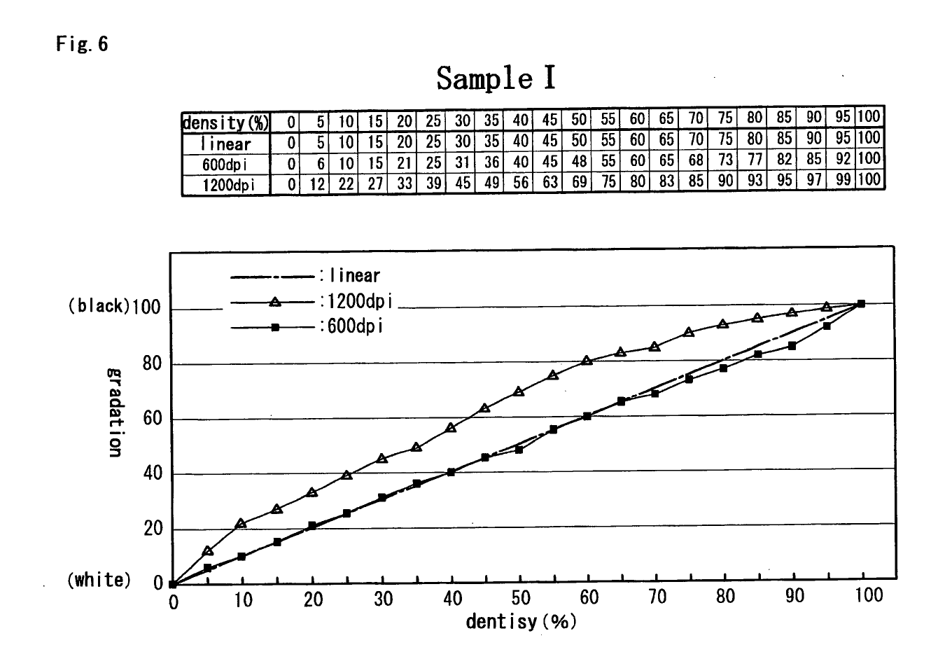

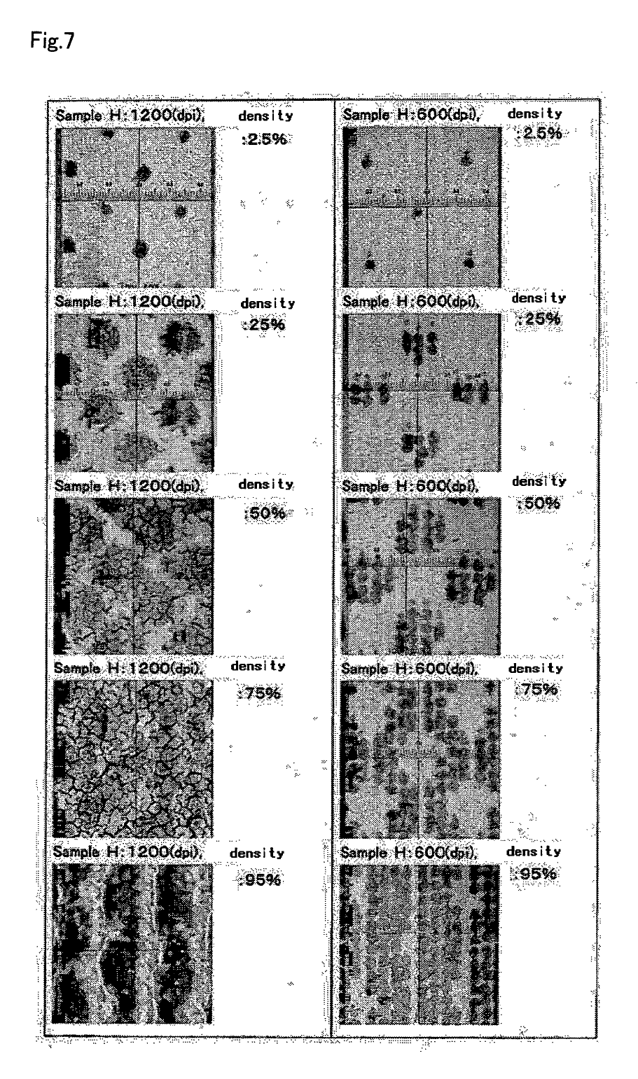

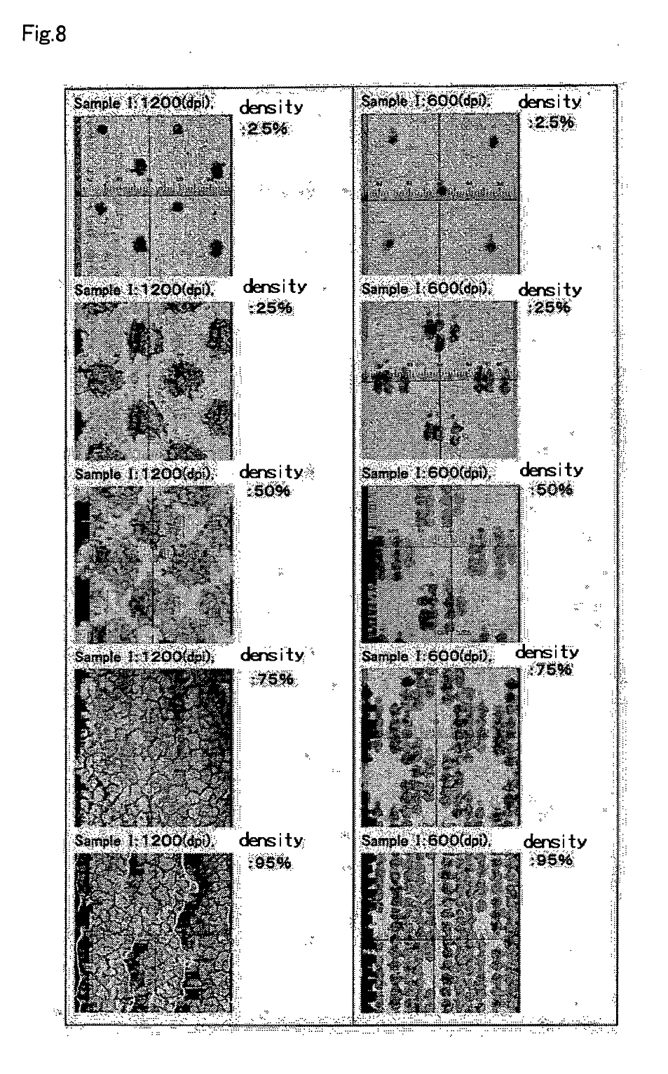

The results obtained with Samples H and I are shown in FIGS. 5 and 6, respectively. Moreover, microphotographs of the surfaces of the image receiving layers of Samples H and I after the platemaking for every concentration region are shown in FIGS. 7 and 8, respectively. Examination of the results shown in FIGS. 7 and 8 revealed that there was no significant difference in the adhesion state of the droplets of lipophilic ink between Samples H and I, and it can be said that the almost same states were obtained.

However, as clearly seen from the results shown in FIGS. 5 and 6, whereas the density/gradation characteristic always markedly shifts to the high gradation side compared with the linear change in the printing of Comparative Example 1, an almost linear change was observed, and thus extremely superior tone reproduction could be realized in Example.

This tendency can be confirmed also in the results shown in FIGS. 7 and 8. That is, in Example (right side), because the 1-dot equal interval thinning was performed for the main scanning direction, blotting ranges of adjacent droplets immediately after the printing did not overlap with one another. In addition, because the droplets are cured by the ultraviolet irradiation in each pass of the printing, adhered individual droplets are independent form one another and in the spherical forms immediately after the printing, even under a high density printing condition.

On the other hand, in the case of Comparative Example 1 (left side), the blotting regions of adjacent dots began to overlap with one another at a density of about 25%. And when the density became further higher, the blotting regions connected for all directions, resulting in a condition that shapes of the droplets could hardly be observed, and because the blotting regions were cured in a two-dimensionally enlarged state, cracks were generated.

This difference notably appeared as difference in change of gradation in the results shown in FIGS. 5 and 6, and it verifies how significant the effect of performing dot thinning printing for the main scanning direction and the subscanning direction and curing droplets of lipophilic ink for every pass in multipass printing is.

### Comparative Example 2

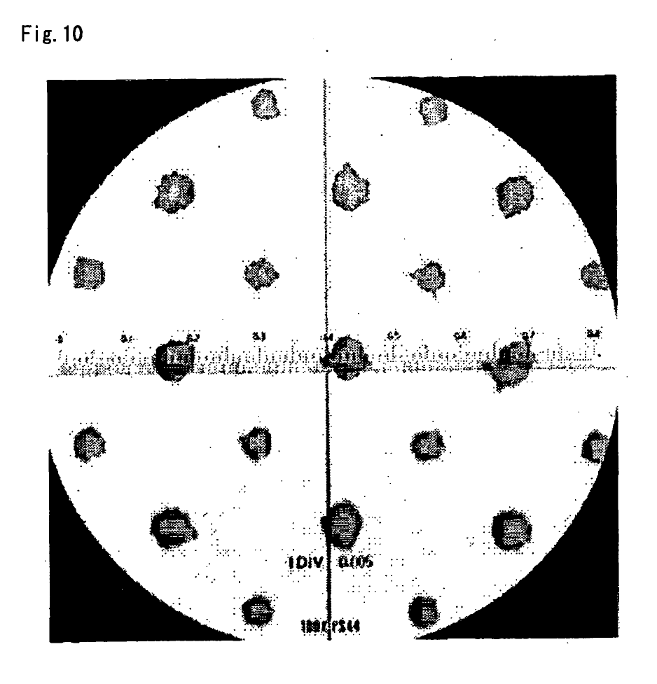

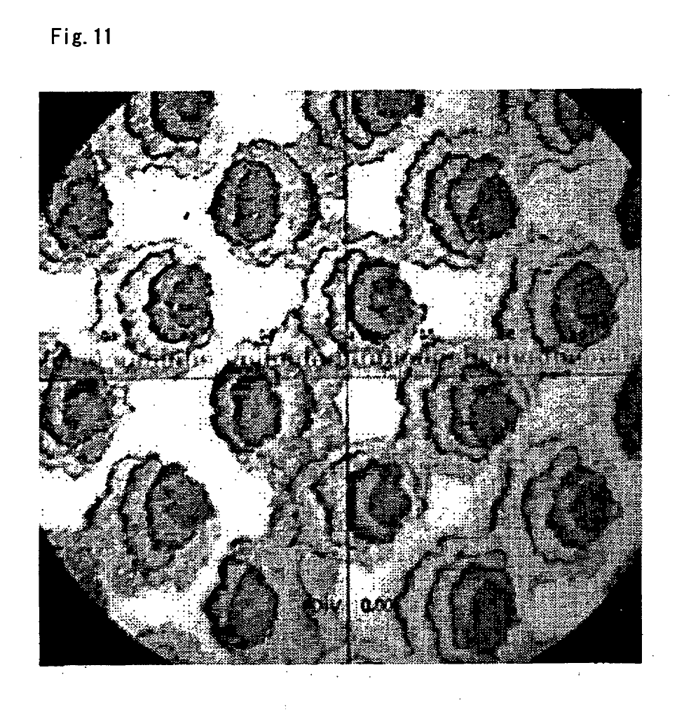

Further, by using the same materials as the printing plate material (Sample H) and lipophilic ink used in the example and Comparative Example 1, printing was performed with a printing head based on the inkjet method (resolution: 1200 dpi, droplet: 1 drop consisted of 6 pl), and droplets were cured by ultraviolet irradiation after all the dot printing was completed. The result of 1-dot printing and 2-dot printing alternately performed along the subscanning direction at a density of 2.5% is shown in FIG. 10, and the result of 4-dot printing performed at a density of 25% in a neighboring area is shown in FIG. 11.

As clearly seen from these results, when ultraviolet rays were irradiated after all the dot printing was completed, as the amount of ink adhered in a unit area of the printing plate material increased, blotting became severer, and as the density became higher, the shapes of the blotting regions were irregularly collapsed.

### INDUSTRIAL APPLICABILITY

The present invention can be applied to platemaking apparatuses for preparing offset printing plates.

### BRIEF DESCRIPTION OF THE DRAWINGS

[FIG. 1] A diagram showing configuration of an embodiment of the platemaking apparatus of the present invention

[FIG. 2] A drawing showing printing condition in each pass of multipass printing according to the dot thinning printing method employed in the platemaking apparatus of the present invention

[FIG. 3] A flowchart showing operation procedure of the first embodiment of the present invention

[FIG. 4] A drawing showing printing condition of each pass in multipass printing with no dot thinning for the main scanning direction

[FIG. 5] Data and graph showing density/gradation characteristics of the printing plates obtained from Sample H in the example and Comparative Example 1

[FIG. 6] Data and graph showing density/gradation characteristics of the printing plates obtained from Sample I in the example and Comparative Example 1

[FIG. 7] Microphotographs of the printing plate obtained from Sample H for printed areas at various densities (2.5%, 25%, 50%, 75%, 95%)

[FIG. 8] Microphotographs of the printing plate obtained from Sample I for printed areas at various densities (2.5%, 25%, 50%, 75%, 95%)

[FIG. 9] A flowchart showing operation procedure of the first embodiment of the present invention

[FIG. 10] A microphotograph of a printing plate printed with droplets of lipophilic ink (alternate 1-dot printing and 2-dot printing for the subscanning direction at a density of 2.5%) by using a printing head based on the inkjet method (resolution: 1200 dpi, droplet: 1 drop is 6 pl.)

[FIG. 11] A microphotograph of a printing plate printed with droplets of lipophilic ink (4-dot printing in neighboring area at a density of 25%) by using a printing head based on the inkjet method (resolution: 1200 dpi, droplet: 1 drop is 6 μl)

### EXPLANATION OF NOTATIONS

1 . . . Printing plate material feed bar, 2 . . . printing plate material, 3,9 . . . motor, 4 . . . printing plate feeding mechanism, 5 . . . fixing casing, 6 . . . printing head, 7 . . . UV lamp, 8 . . . carriage, 10 . . . carriage feeding mechanism, 11 . . . head driver, 12 . . . lamp driver, 13 . . . system controller, 14 . . . feed controller, 15 . . . head controller, 16 . . . lamp controller, 17 . . . image processing means.

1. A method for preparing an offset printing plate comprising scanning an image receiving layer provided on a surface of a support with a printing means based on the inkjet method discharging droplets of lipophilic ink to form images of the printing plate,
wherein ink having an ionizing radiation curing property is used as the lipophilic ink, multipass printing is performed with a printing head of the printing means with dot thinning for a main scanning direction and a subscanning direction, and droplets adhered on the image receiving layer in each pass of the multipass printing are cured by irradiation of ionizing radiation during a period after adhesion of the droplets and before start of printing in the next pass.

2. The method for preparing an offset printing plate according to claim 1, wherein both the printing head of the printing means and an ionizing radiation irradiation unit are installed on a carriage moving along the main scanning direction so as to irradiate the printed droplets with ionizing radiation.

3. The method for preparing an offset printing plate according to claim 2, wherein irradiation by the ionizing radiation irradiation unit is maintained also during a period of returning movement of the printing head after completion of printing in each pass.

4. The method for preparing an offset printing plate according to claim 3, wherein after the return of the carriage after completion of printing in each pass, the carriage is reciprocally moved one or more times along the main scanning direction with maintaining the irradiation by the ionizing radiation irradiation unit and non-printing state of the printing head.

5. A platemaking apparatus comprising a printing means provided with a printing head for performing printing by injecting ink droplets to a printing plate material, a carriage carrying the printing head, a driving means for reciprocally moving the carriage along a first direction with the printing head facing the printing plate material, a carrying means for intermittently feeding the printing plate material along a second direction perpendicular to the first direction, and a control means for controlling operations of the driving means, the printing means, and the carrying means,
wherein the carriage carries an ionizing radiation irradiation unit for curing ink droplets injected on the printing plate material by the printing head, and
the control means performs such control that multipass printing should be performed to repeat printing with thinning dots of printing data for the first and second directions, and the ink droplets injected on the printing plate material by the printing head in printing of each pass should be irradiated with ionizing radiation during a period after injection of the droplets and before start of printing in the next pass.
